(19) United States
(12) Patent Application Publication
(10) Pub. No.: US 2009/0267537 A1
(43) Pub. Date: Oct. 29, 2009

(54) Motion activated removable blinking shoe light

(76) Inventor: David Rubinstin, Boca Raton, FL (US)

Correspondence Address: RUTH EURE, 4795 EDISON AVENUE, BOULDER, CO, 80301, US

(21) Appl. No.: 12/387,168

(22) Filed: Apr. 29, 2009

Related U.S. Application Data
(60) Provisional application No. 61/125,823, filed on Apr. 29, 2008.
(60) Provisional application No. 61/128,760, filed on May 23, 2008.

(51) Int. Cl. H05B 37/02; F21V 21/08

(52) U.S. Cl. 315/297; 362/103

(57) ABSTRACT

A motion activated removable waterproof multi-colored blinking shoe light comprising a decorative top which attaches to a shoe by means of any appropriate fastening means such as a thin rubber or plastic snap, loop for receiving a shoe lace, any other loop, clasp, or pinching device, for example, is provided.

### CLAIM OF PRIORITY

This patent application claims priority from U.S. Provisional patent application Ser. No. 61/125,823, filed Apr. 29, 2008, and U.S. Provisional patent application Ser. No. 61/128,760, filed May 23, 2008.

### FIELD OF THE INVENTION

The present invention relates to the field of shoe accessories, and more specifically to the field of removable shoe accessories, and even more specifically to the field of removable shoe lights.

### BACKGROUND OF THE INVENTION

Several shoe adornment accessories have been put forth by the prior art. These include, for example, U.S. Pat. No. 5,496,612 to Ransbottom which describes a shoe ornament attached to an elastic band which is then stretched over the vamp of the shoe.

Another example is found in U.S. Pat. No. 7,071,828 to Wong which describes a wearable band with motion detection and flashing lights.

U.S. Pat. No. 6,789,913 to Wei describes a multifunctional shoe flashing device which comprises a device embedded into the sole of a shoe which is activated due to external forces and activates flashing of the lighting device in a sequential manner.

U.S. Pat. No. 6,525,487 to Wei describes a light driver for shoe which comprises a switch unit for activating a light which is embedded into the sole of a shoe.

U.S. Pat. No. 6,764,193 to Wei describes a full color shoe light device which is also embedded into the sole of a shoe and provides more than one color LED light.

None of these prior art references describe the teachings of the instant invention.

### SUMMARY OF THE PRESENT INVENTION

It is an object of the present invention to provide a motion activated removable waterproof multi-colored shoe light which attaches to the top of a shoe by means of any appropriate fastening means such as a thin rubber or plastic snap, loop for receiving a shoe lace, any other loop, clasp, or pinching device, for example.

It is an object of the present invention to provide a motion activated removable waterproof shoe light having a replaceable battery.

It is a further object of the present invention to provide a motion activated removable waterproof shoe light having a non-replaceable battery.

It is a further object of the present invention to provide a motion activated removable shoe light which comprises interchangeable decorative tops.

It is a further object of the present invention to provide a motion activated removable shoe light which attaches to a shoe lace or buckle strap by means of too loops on the back of the housing for threading through a shoe lace or buckle strap.

### BRIEF DESCRIPTION OF THE DRAWINGS

FIG. 1 is a perspective top view of the shoe light of the present invention.

FIG. 2 is a perspective back view of the shoe light of the present invention showing one attachment means.

FIG. 3 is a top view of the shoe light of the present invention showing loops for attachment means.

FIG. 4 is a side view of the shoe light of the present invention showing loops for attachment means.

FIG. 5 is a schematic of one motion detection mechanism.

FIG. 6 is a top view of an alternative embodiment of the shoe light of the present invention.

FIG. 7 is a top view of an alternative embodiment of the shoe light of the present invention.

FIG. 8 is a top view of an alternative embodiment of the shoe light of the present invention.

FIG. 9 is a top view of an alternative embodiment of the shoe light of the present invention.

FIG. 10 is a side view of the device of the present invention showing alternative fastening means in the form of a plastic snap.

FIG. 11 is an x-ray view of the device showing the LED lights.

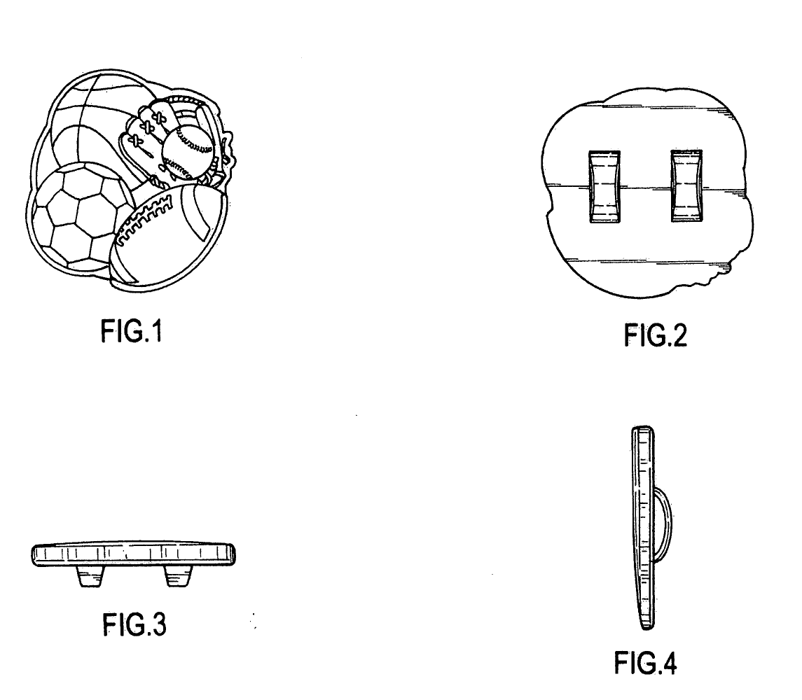

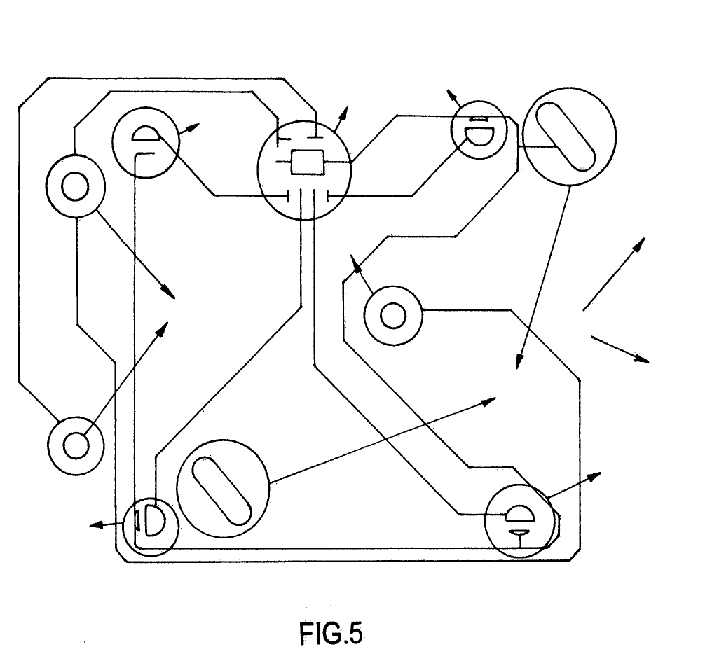

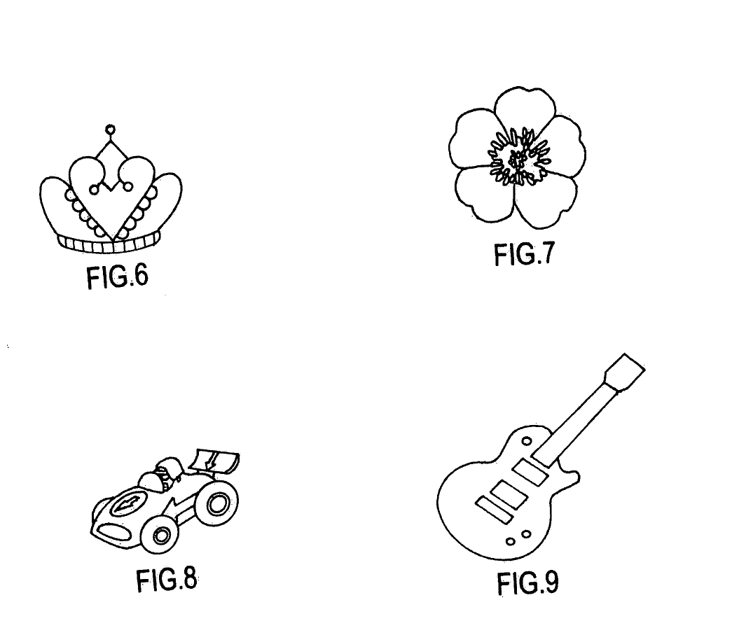

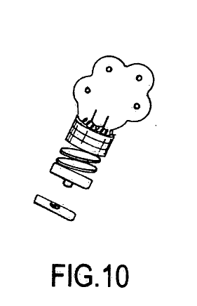

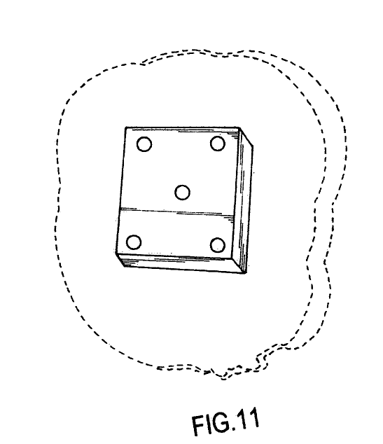

### DETAILED DESCRIPTION OF THE PRESENT INVENTION

The present invention provides a shoe light comprising an LED (light emitting diode) light source which is powered by a battery such as a coin cell battery, for example. The light source comprises one or more LED lights in one or more colors. The LEDs used in the present invention are lightweight, low heat producing lamps which provide adequate illumination so that the illumination can be easily seen during the day or at night. The invention also comprises a motion sensor for activating and de-activating the light source. The motion sensor circuit and the power supply are encased in a plastic housing. In an alternative embodiment, the light is actuated by means of a spring that moves inside the housing and makes contact to the power source when the contact end of the spring touches the power supply. This occurs when the shoe is moved. The pattern of light emission can vary according to the elasticity and placement of the one or more springs.

In an alternative embodiment, the motion sensor comprises a digital output signal that can be connected directly to the digital processing and control circuits of a device. The motion sensor includes an enclosed housing having a conductive element therein that partially fills the space of a cavity within the enclosed housing. The conductive element is free to roll, flow or otherwise move around the inside of the housing in response to external forces. The external forces that cause the conductive element to move include the physical motion of the wearer as well as the force of gravity. As the conductive element moves within the enclosed housing, it makes electrical contact with at least two of three electrodes that are selectively spaced around the inside periphery of the housing. This housing can be of any appropriate geometric configuration, such as a disc or tablet, for example.

The plastic housing is designed to create a waterproof encasement for the device. This will prevent malfunction of the device in case of rain, snow or other inclement conditions.

In an alternative embodiment, the housing comprises a two-part waterproof plastic housing, such as silicon or ABS plastic, for example, which provides for replacing the battery. The two-part housing can be closed by having a threaded engagement means, or a ridge and groove along the periphery for creating a waterproof snap fit. There is no metal on the outside of the device.

An important feature of the present invention is that it is made of materials which are in compliance with the Consumer Product Safety Improvement Act limiting amounts of lead, mercury chromium and phthalates according to guidelines forecast for 2011.

The control circuit of the present invention is preprogrammed to blink or light in a predetermined sequence.

The plastic housing is attached to the shoe by any appropriate fastening means such as a thin rubber, plastic or other waterproof snap, or loop for receiving a shoe lace, any other loop, clasp, or pinching device, for example. If a snap is used, it can be attached to the bottom of the plastic housing. The light source is attached to the top of the plastic housing and can be configured in a variety of decorative designs. The lights can be blinking or continuously on. The pattern of light emission can vary according to the programming of the circuitry encased in the plastic housing.

The attachment means of one embodiment comprises two loops on the back of the housing for threading through a shoe lace or buckle strap.

The attachment means of an alternative embodiment comprises a plastic snap which includes a protuberance for feeding through a hole in the shoe and a top which snaps onto the protuberance. The housing which includes the light device is mounted on the top which snaps onto the post.

The top of the removable shoe light of the present invention can be of any decorative configuration. By way of example, and not intending to be limited thereby, more than one top is illustrated. It is contemplated that an alternative embodiment would encompass interchangeable tops so that one light could accommodate more than one decorative top.

In an embodiment, the battery is not replaceable and one advantage of having a motion sensor is to extend the life of the battery thereby making the product more useful.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A removable shoe flashing device for removable attachment to a shoe comprising at least one housing, at least one battery, at least one decorative top, a lighting device, a motion sensor, a control circuit wherein the housing is waterproof, and the decorative top is removably attached to the device.

2. The device of claim 1 wherein the lighting device comprises one or more LEDs and wherein the LEDs emit one or more colors.

3. The device of claim 1 wherein the battery is a coin cell battery.

4. The device of claim 1 wherein the battery is replaceable.

5. The device of claim 1 wherein the motion sensor comprises an enclosed housing having a conductive element therein that partially fills the space of a cavity within the enclosed housing wherein the conductive element is free to roll, flow or otherwise move around the inside of the housing in response to external forces, wherein as the conductive element moves within the enclosed housing, it makes electrical contact with at least two of three electrodes that are selectively spaced around the inside periphery of the housing.

6. The device of claim 5 wherein the external forces that cause the conductive element to move include the physical motion of the wearer as well as the force of gravity.

7. The device of claim 1 wherein the control circuit is programmed to blink or light in a predetermined sequence.

8. The device of claim 1 further comprising attachment means for attaching the device to a shoe.

9. The device of claim 8 wherein the attachment means comprises two loops on the back of the housing for threading through a shoe lace or buckle strap.

10. The device of claim 8 wherein the attachment means comprises a plastic snap which further comprises a protuberance for feeding through a hole in the shoe and a decorative top which snaps onto the protuberance, wherein the housing which includes the light device is mounted on the decorative top which decorative top snaps onto the post.
